(19) United States
(12) Patent Application Publication
(10) Pub. No.: US 2011/0063158 A1
(43) Pub. Date: Mar. 17, 2011

(54) Array antenna apparatus and radar apparatus

(75) Inventor: Asahi Kondou, Kariya-shi (JP)

(73) Assignee: DENSO CORPORATION, Kariya-city (JP)

(21) Appl. No.: 12/807,605

(22) Filed: Sep. 9, 2010

(30) Foreign Application Priority Data
Sep. 17, 2009 (JP) 2009-215751

(51) Int. Cl. H01Q 3/00; G01S 13/04

(52) U.S. Cl. 342/27; 342/371

(57) ABSTRACT

An array antenna apparatus includes a transmission-array-antenna including transmission-antenna-elements, a transmission-side directivity control unit controlling a directivity of the transmission-array-antenna by controlling phases of at least part of the transmission-antenna-elements, a reception-array-antenna including reception-antenna-elements, and a reception-side directivity control unit controlling a directivity of the reception-array-antenna by controlling phases of the reception-antenna-elements. The array antenna apparatus has a composite transmission/reception directivity, in which the direction of a grating lobe of one of the transmission-array-antenna and the reception-array-antenna agrees with the direction of a null point or part of side lobes of the other of the transmission-array-antenna and the reception-array-antenna, and the direction of a grating lobe of the other of the transmission-array-antenna and the reception-array-antenna agrees with the direction of a null point or part of side lobes of the one of the transmission-array-antenna and the reception-array-antenna, and scans in a scanning range with the composite transmission/reception directivity.

### CROSS-REFERENCE TO RELATED APPLICATION

This application is based on and claims the benefit of priority from earlier Japanese Patent Application No. 2009-215751 filed Sep. 17, 2009, the description of which is incorporated herein by reference.

### BACKGROUND OF THE INVENTION

1. Technical Field of the Invention

The present invention relates to an array antenna apparatus which can suppress grating lobes and to a radar apparatus that detects a target located within a scanning range of a main lobe by using the array antenna apparatus.

2. Related Art

The technique for providing such array antenna apparatus and radar apparatus is known as disclosed, for example, in the patent document JP-B-4147447. In the technique disclosed in the patent document JP-B-4147447, a radar apparatus includes an array antenna apparatus which is configured by a transmission array antenna having a plurality of antenna elements, a transmission processing unit connected to the transmission array antenna, a reception array antenna having a plurality of antenna elements, and a reception processing unit connected to the reception array antenna.

This radar apparatus detects a target located within a scanning range of a main lobe, with a composite transmission/reception directivity in which the direction of a grating lobe of the transmission array antenna, i.e. a grating suppressed side, agrees with the direction of null points of the reception array antenna, i.e. a grating suppressing side. The term “composite transmission/reception directivity” refers to a directivity resulting from the composition of the directivity on a grating suppressed side and the directivity on a grating suppressing side.

Thus, the composite transmission/reception directivity can permit the direction of the grating lobe on a grating suppressed side to agree with the direction of the null points on a grating suppressing side. Accordingly, the sensitivity in the direction of the grating lobe on a grating suppressed side can be suppressed, while the target located within the scanning range of the main lobe can be detected.

A grating suppressed side does not necessarily have a single grating lobe but has a plurality of grating lobes. Similarly, a grating suppressing side not only has a main lobe but also has a plurality of grating lobes. Further, the lobes on a grating suppressed side as well as the lobes on a grating suppressing side have the same directional intervals. These respective grating lobes may be referred to a primary grating lobe, a secondary grating lobe, . . . an Nth grating lobe, or may be referred to a first grating lobe, a second grating lobe, . . . an Nth grating lobe, in order of increasing distance from the main lobe.

According to the technique described in the above patent document JP-B-4147447, the direction of the first grating lobe on a grating suppressed side agrees with the direction of the null points between the main lobe and the first grating lobe on a grating suppressing side. Accordingly, the sensitivity in the direction of the first grating lobe on the grating suppressed side can be suppressed with the composite transmission/reception directivity.

However, although not disclosed in the above patent document JP-B-4147447, the directional interval between the lobes on the grating suppressing side is larger “by a factor of two” than the directional interval between the lobes on the grating suppressed side (refer to FIG. 2 of JP-B-4147447). Thus, the direction of the second grating lobe on the grating suppressed side will agree with the direction of the first grating lobe on the grating suppressing side. For this reason, with the technique described in JP-B-4147447, the sensitivity in the direction of the second grating lobe on the grating suppressed side cannot be suppressed with the composite transmission/reception directivity. Therefore, there is a concern that a target detection error may be caused if the direction of the second grating lobe on the grating suppressed side is included in the visible region.

In order to remove such a concern, the interval between the antenna elements may be reduced so that the direction of the second grating lobe on the grating suppressed side will not agree, in the visible region, with the direction of the first grating lobe on the grating suppressing side. Specifically, let us take an example in which a visible region extends to within “±90°”. In order that the directions of the grating lobes will not agree with each other in this visible region, the interval between the antenna elements on a grating suppressing side may be set to “one half” or less of a wavelength λ of the radio waves in use.

However, it is physically difficult to set the interval between the antenna elements on a grating suppressing side to such a small interval. Because of this difficulty, the visible region, per se, is necessitated to be made smaller so that no grating is caused. Reducing a visible region, per se, may lead to reducing the detection range of a target. Thus, the technique disclosed in the patent document JP-B-4147447 still leaves room for improvement.

### SUMMARY OF THE INVENTION

The present invention has been made in light of the circumstances described above, and has as its object to provide an array antenna apparatus which is able to broaden a visible region, while increasing the interval between antenna elements and to provide a radar apparatus which is able to detect a target using the array antenna apparatus.

In order to achieve the object, the present invention provides, as one aspect, an array antenna apparatus, including: a transmission array antenna which includes a plurality of transmission antenna elements; a transmission-side directivity control unit which controls a directivity of the transmission array antenna by controlling phases of at least part of the plurality of transmission antenna elements; a reception array antenna which includes a plurality of reception antenna elements; and a reception-side directivity control unit which controls a directivity of the reception array antenna by controlling phases of at least part of the plurality of reception antenna elements, wherein the array antenna apparatus has a composite transmission/reception directivity, in which the direction of a grating lobe of one of the transmission array antenna and the reception array antenna agrees with the direction of a null point or part of side lobes of the other of the transmission array antenna and the reception array antenna, and the direction of a grating lobe of the other of the transmission array antenna and the reception array antenna agrees with the direction of a null point or part of side lobes of the one of the transmission array antenna and the reception array antenna, and scans in a scanning range with the composite transmission/reception directivity.

### BRIEF DESCRIPTION OF THE DRAWINGS

In the accompanying drawings:

FIG. 1 is a block diagram illustrating a general configuration of a radar apparatus which includes an array antenna apparatus according to an embodiment;

FIG. 2 is a diagram illustrating an example of an array factor AF(u);

FIG. 3 is a diagram illustrating an example of an array factor AF(θ) in the case where the direction of a main lobe is “45°”;

FIG. 4 is a diagram illustrating an example of the directivity of a transmission array antenna and an example of the directivity of a reception array antenna, for explaining the principle of occurrence of a grating lobe;

FIG. 5 is a diagram illustrating an example of composite transmission/reception directivity resulting from the composition of the directivity of a transmission array antenna and the directivity of a reception array antenna, for explaining a method of suppressing grating lobes;

FIG. 6 is a diagram illustrating an example of the directivity of a transmission array antenna and an example of the directivity of a reception array antenna with a broken line and a solid line, respectively, according to the embodiment;

FIG. 7 is a diagram illustrating composite transmission/reception directivity resulting from the composition of the directivity of the transmission array antenna and the directivity of the reception array antenna, according to the embodiment;

FIG. 8 is a block diagram illustrating a general configuration of a radar apparatus, according to a modification of the embodiment;

FIG. 9 is a block diagram illustrating a general configuration of a radar apparatus, according to another modification of the embodiment; and

FIG. 10 is a block diagram illustrating a general configuration of a radar apparatus, according to still another modification of the embodiment.

### DETAILED DESCRIPTION OF THE PREFERRED EMBODIMENTS

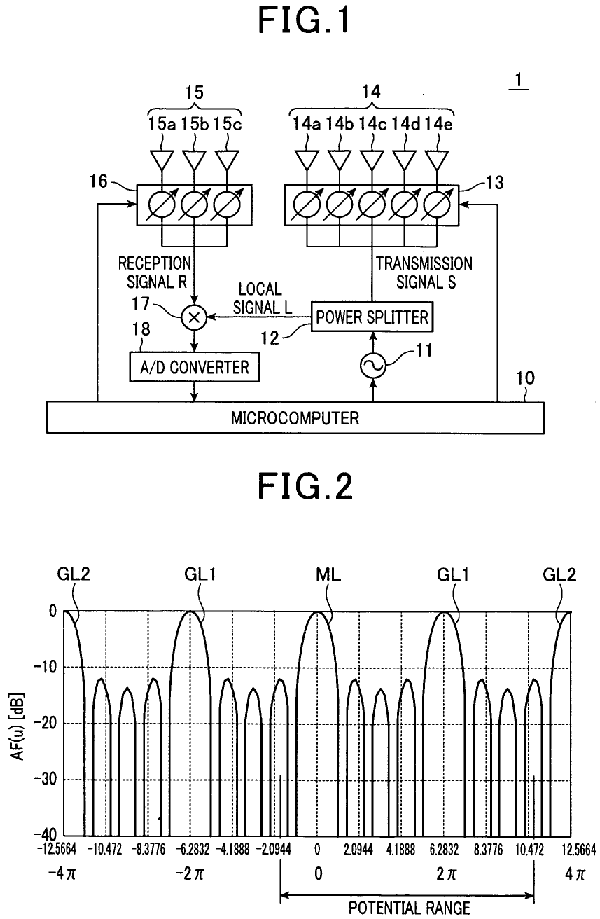

With reference to FIGS. 1 to 7, hereinafter will be described an embodiment of a radar apparatus that includes an array antenna apparatus. FIG. 1 is a block diagram illustrating a general configuration of a radar apparatus 1 that includes an array antenna apparatus according to the present embodiment. Referring to FIG. 1, the configuration and functions of the radar apparatus 1 are described first.

As shown in FIG. 1, the radar apparatus 1 includes a microcomputer 10, oscillator 11, power splitter 12, transmission-side phase shifter 13, transmission array antenna 14, reception array antenna 15, reception-side phase shifter 16, mixer 17 and A/D converter 18.

The microcomputer 10 is connected to the oscillator 11 so as to be located upstream of the oscillator 11, while the power splitter 12 is connected to the oscillator 11 so as to be located downstream of the oscillator 11. The oscillator 11 gives oscillation in a frequency band (e.g., millimeter-wave band) allocated by the microcomputer 10. At the same time, the oscillator 11 produces a high-frequency signal that changes into a triangular wave and outputs the produced high-frequency signal to the power splitter 12.

The transmission array antenna 14 is connected to the power splitter 12 via the transmission-side phase shifter 13 so as to be located downstream of the power splitter 12. The mixer 17 is connected to the power splitter 12. The power splitter 12 splits the high-frequency signal inputted from the oscillator 11 into a transmission signal S and a local signal L. Then, the power splitter 12 outputs the transmission signal S to the transmission array antenna 14 via the transmission-side phase shifter 13 and outputs the local signal L to the mixer 17.

The transmission-side phase shifter 13 is disposed between the transmission array antenna 14 and the power splitter 12, while being connected to the microcomputer 10. The transmission array antenna 14 is configured by a plurality of (e.g., five) transmission antenna elements 14a to 14e which are arrayed at regular intervals on a plane (on an antenna surface), not shown. The transmission-side phase shifter 13 sets an amount of phase shift of each of the transmission signals S inputted to the transmission antenna elements 14a to 14e from the power splitter 12, according to the instructions of the microcomputer 10.

Thus, the transmission signals (electric signals) S are inputted from the power splitter 12 via the transmission-side phase shifter 13. The transmission array antenna 14 radiates these transmission signals S to the outside through the transmission antenna elements 14a to 14e in the form of transmission beams (radio waves). The direction of each transmission beam depends on the amount of phase shift of the transmission signal S inputted to each of the transmission antenna elements 14a to 14e.

The direction of each transmission beam is determined based on the antenna surface of the transmission array antenna 14. Specifically, the direction perpendicular to the antenna surface is “0°” and the direction parallel to the antenna surface is “±90°”. The phase of the transmission signal is controlled for each of the transmission antenna elements 14a to 14e. Thus, the transmission array antenna 14 can radiate the transmission beams in a desired directional range. In other words, the directivity of the transmission array antenna 14 is variable.

On the other hand, the reception array antenna 15 is configured by a plurality of (e.g., three) reception antenna elements 15a to 15c which are arrayed at regular intervals on a plane, not shown. The reception antenna elements 15a to 15c are connected to the mixer 17 via the reception-side phase shifter 16. When the transmission beams (radio waves) radiated from the transmission array antenna 14 are reflected by a target, the reception antenna elements 15a to 15c of the reception array antenna 15 receive the reflected beams (radio waves). Then, the reception antenna elements 15a to 15c output the received reflected beams to the reception-side phase shifter 16 in the form of reception signals (electric signals) R. The reception-side phase shifter 16 sets an amount of phase shift of each of the reception signals R inputted from the reception antenna elements 15a to 15c, according to the instructions of the microcomputer 10, and then outputs the reception signals R to the mixer 17.

Thus, the reception signals R are inputted to the mixer 17 from the reception-side phase shifter 16 which is connected upstream of the mixer 17. The microcomputer 10 is connected to the mixer 17 via the A/D converter 18 so as to be located downstream of the mixer 17. The mixer 17 mixes the reception signals R inputted from the reception-side phase shifter 16 with the local signals L inputted from the power splitter 12 (performs synchronous detection) to thereby take out base band signals. The taken out base band signals are converted to digital signals by the A/D converter 18, and then the converted digital signals are outputted to the microcomputer 10.

The direction of each reflected beam incident (hereinafter referred to as “incident direction” of the reflected beam) on the reception array antenna 15 depends on the amount of phase shift (phase difference) of each of the reception signals R outputted from the reception antenna elements 15a to 15c. The incident direction of the reflected beam is determined based on the antenna surface of the reception array antenna 15. Specifically, the incident direction perpendicular to the antenna surface is “0°”, while the incident direction parallel to the antenna surface is “±90°”. The phase of the reception signal R is controlled for each of the reception antenna elements 15a to 15c. Thus, the reception array antenna 15 can receive the reflected beams from within a desired directional range.

The microcomputer 10 is mainly configured by a microcomputer that includes a CPU, ROM, RAM, backup RAM and I/O (which are all not shown). The microcomputer 10 is provided with a processing unit (e.g., DSP (digital signal processor)) that performs a fast Fourier transform (FFT) process for the base band signals acquired from the mixer 17 via the A/D converter 18. The microcomputer 10 performs various processes by executing various control programs stored in the ROM.

The microcomputer 10 scans, first, the radiation angle of a main lobe, in a detection range from “−90°” to “+90°” for a target, while permitting the transmission array antenna 14 to radiate transmission waves. (Thus, the detection range for a target corresponds to the scanning range.) When a target is located in the detection range, the transmission waves radiated from the transmission array antenna 14 are reflected by the target. The reflected waves are then received by the reception array antenna 15. The microcomputer 10 determines whether or not the intensity of each reception signal R received by the reception array antenna 15 is equal to or more than a threshold. The microcomputer 10, when it determines that the intensity of the signal is equal to or more than the threshold, detects the direction of the target using the phase difference (phase shift) of the reception signal R.

In this way, the radar apparatus 1 uses a so-called electronic scanning method. The microcomputer 10 corresponds to an object detection unit. In the present embodiment, the antenna surface of the transmission array antenna 14 is made parallel to that of the reception array antenna 15, and the detection range for a target ranges from “−90°” to “+90°”.

Hereinafter is described the principle of occurrence of a grating lobe. An array factor AF that is a transfer function of an array antenna is expressed by the following Expression (1). In the expression, An is the amplitude of each wave source, d is the element interval of antenna elements, θ₀ is the direction of a main lobe and N is the number of antenna elements.

$$AF ( θ ) = {\sum }_{n = 1}^{N} An exp [ j \{ - \frac{2 π}{λ} ( n - 1 ) d ( sin θ - sin {θ}_{0} ) \} ] \qquad Expression ( 1 )$$

An array antenna has a main lobe, a grating lobe, a side lobe, a null point and the like in a periodic fashion. Among them, the grating lobe refers to a lobe having a peak substantially the same as that of the main lobe. The side lobe refers to a lobe having a peak which is low compared to those of the main lobe and the grating lobe. Each of these lobes has a certain width which depends on the element interval of the antenna elements. In the present embodiment, the main lobe corresponds to a directional range that includes a peak and extends lowering from the peak by “10 dB”, for example. The grating lobe corresponds to a directional range that includes a peak and extends lowering from the peak by “10 dB”, for example. The side lobe corresponds to a directional range that includes a peak and extends lowering from the peak by “5 dB”, for example. However, the lowering extents are not limited to “10 dB” and “5 dB”. These lobes may have ranges that are not overlapped with each other and are identifiable from each other. Further, the null point corresponds to a direction that causes an abrupt drop of gain. Null points occur between lobes.

Here, a new variable u is defined as expressed by the following Expression (2): Also, for the sake of simplification of explanation, the above Expression (1) is expressed as the following Expression (3) when An is “1”.

$$\begin{matrix}u = - \frac{2 π}{λ} d ( sin θ - sin {θ}_{0} ) & Expression ( 2 ) \\ AF ( u ) = {\sum }_{n = 1}^{N} exp \{ j ( n - 1 ) u \} & Expression ( 3 )\end{matrix}$$

FIG. 2 is a diagram illustrating an array factor AF (u) in the case where, for example, the element interval d is set to be the same as the wavelength λ and the number of elements N of the antenna elements is set to “5”.

As shown in FIG. 2, the array factor AF(u) has a main lobe ML, a first grating lobe GL1 and a second grating lobe GL2 at a cycle “2π”. Meanwhile, an exponential function is used in the above Expression (3). Thus, it will be understood from FIG. 2 and Expression (3) that the array factor AF(u) is a function having a cycle “2π” for the variable u.

Further, let us discuss the case where the direction θ₀ of the main lobe ML is set to “π/4 (=45°)”. In this case, the potential range of the variable u can be expressed by the following Expression (4). Such a range of the variable u is referred to a “visible range”. The visible range is indicated by an arrow in FIG. 2.

(\sqrt{2}−2)π≦u≦(\sqrt{2}+2)π Expression (4)

It will be understood from Expression (2) that the potential range of the variable u (i.e. visible range) becomes larger as the element interval d becomes larger. On the other hand, a direction θGL of the grating lobe corresponds to the direction defined by Expression (2) with its right side being “±2πm (m=1, 2, 3, . . . )”, that is, corresponds to the direction that constitutes the following Expression (5). Accordingly, it will be understood that, as the element interval d becomes larger, the grating lobe is likely to enter the visible region. It should be noted that the following Expression (6) is an expression that solves Expression (5) for the direction θ. For comparison, a direction θML of the main lobe corresponds to the direction defined by Expression (5) when “m=0”.

$$\begin{matrix}u = - \frac{2 π}{λ} d ( sin θ - sin {θ}_{0} ) = \pm 2 π m ( m = 1 , 2 , 3 , … ) & Expression ( 5 ) \\ {θ}_{GLm} = {sin}^{- 1} ( \pm \frac{λ m}{d} + sin {θ}_{0} ) & Expression ( 6 )\end{matrix}$$

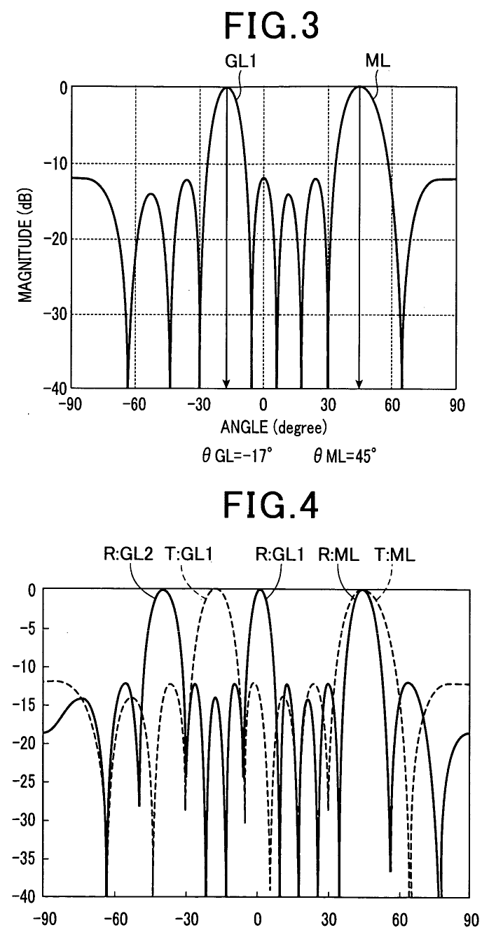

FIG. 3 is a diagram illustrating an array factor AF(θ) with the horizontal axis of FIG. 2 being replaced by on indicating the direction θ. In FIG. 3, the direction θ₀ of the main lobe is set to “π/4 (=45°)”.

As shown in FIG. 3, in the array factor AF(θ), the first grating lobe has a direction θGL1 (=“−17°”) when the direction θML of the main lobe ML is “45°”.

Hereinafter is explained a method of suppressing the occurrence of grating in a visible region. In the explanation, AT represents the transmission array antenna and AR represents the reception array antenna.

First, an explanation is given for the technique corresponding to the technique disclosed in the patent document JP-B-4147447, a conventional art, mentioned above. The directional interval, in the conventional art, between the lobes of the transmission array antenna AT is larger by a factor of two than the directional interval between the lobes of the reception array antenna AR.

Specifically, the wavelength of the radio waves used for the transmission array antenna AT and the reception array antenna AR is represented by λ. In this case, for example, an element interval Dt of the transmission antenna elements that constitute the transmission array antenna AT is set to be “equal to twice of the wavelength λ”. Also, for example, an element interval Dr of the reception antenna elements that constitute the reception array antenna AR is set to be “equal to the wavelength λ”. In other words, let us assume that a relationship “Dt=Dr×2.0” is established between the element interval Dt of the transmission antenna elements and the element interval Dr of the reception antenna elements.

With this relationship, when a main lobe T:ML of the transmission array antenna AT has a direction expressed by “direction θ₀=45° (=ASIN (1/√2))”, a first grating lobe T:GL1 will have a direction expressed by “direction θTGL1=12° (=ASIN (−¼+1/√2))” as derived from Expression (6). Also, in this case, a second grating lobe T:GL2 will have a direction expressed by “direction θTGL2=−17° (=ASIN (−1+1/√2))” as derived from Expression (6).

Further, when a main lobe R:ML of the reception array antenna AR has a direction expressed by “direction θ₀=45° (=ASIN (1/√2))”, a first grating lobe R:GL1 will have a direction expressed by “direction θRGL1=−17° (=ASIN (−1+1/√2))” as derived from Expression (6). Accordingly, by setting the relationship “Dt=Dr×2.0” between the element interval Dt of the transmission antenna elements and the element interval Dr of the reception antenna elements, it is understood that the directional interval between the lobes of the reception array antenna AR reliably becomes “twice” of the directional interval between the lobes of the transmission array antenna AT. It should be noted that “ASIN” indicates an inverse function of a sine function.

In the technique of this conventional art, the direction θTGL2 of the second grating lobe of the transmission array antenna AT agrees, at “−17°”, with the direction θRGL1 of the first grating lobe of the reception array antenna AR. Thus, grating occurs in the visible range (−90° to)+90°. In other words, sensitivity in the direction θTGL2 of the second grating lobe of the transmission array antenna AT can no longer be suppressed with the composite transmission/reception directivity, leading to detection error of a target.

In this regard, in the present suppressing method, the directional interval between the lobes of the transmission array antenna AT is set so as not to be twice of the directional interval between the lobes of the reception array antenna AR.

Specifically, the wavelength of the radio waves used for the transmission array antenna AT and the reception array antenna AR is represented by λ. In this case, for example, the element interval Dt of the transmission antenna elements that constitute the transmission array antenna AT is set to be “equal to the wavelength λ”. Also, for example, the element interval Dr of the reception antenna elements that constitute the reception array antenna AR is set to be “equal to 1.5 times of the wavelength λ”. In other words, let us assume that a relationship “Dr=Dt×1.5” is established between the element interval Dt of the transmission antenna elements and the element interval Dr of the reception antenna elements.

With this relationship, when the main lobe T:ML of the transmission array antenna AT has a direction expressed by “direction θ₀=45° (=ASIN (1/√2))”, the first grating lobe T:GL1 will have a direction expressed by “direction θTGL1=−17° (=ASIN (−1+1/√2))” as derived from Expression (6).

Also, when the main lobe R:ML of the reception array antenna AR has a direction expressed by “direction θ₀=45° (=ASIN (1/√2))”, the first grating lobe R:GL1 will have a direction expressed by “direction θRGL1=2° (=ASIN (−⅔+1/√2))” as derived from Expression (6). Further, in this case, a second grating lobe R:GL2 will have a direction expressed by “direction θRGL2=−39° (=ASIN(−4/3+1/√2))”. For comparison, reference is made to FIG. 4. FIG. 4 is a diagram illustrating the directivity of the transmission array antenna AT and that of the reception array antenna AR by a broken line and a solid line, respectively.

Accordingly, by setting the relationship of “Dr=Dt×1.5” between the element interval Dt of the transmission antenna elements and the element interval Dr of the reception antenna elements, the directional interval between the lobes of the transmission array antenna AT reliably becomes “1.5 times” of the directional interval between the lobes of the reception array antenna AR. Further, it will be understood that the direction θTGL1 of the first grating lobe T:GL1 of the transmission array antenna AT agrees with the central direction between the directions θRGL1 and θRGL2 of the first and second grating lobes R:GL1 and R:GL2 of the reception array antenna AR.

As indicated by the solid line in FIG. 4, the reception array antenna AR has “three” side lobes and “four” null points between the directions of the first and second grating lobes R:GL1 and R:GL2. Of the “three” side lobes, the one having the lowest peak (hereinafter referred to as “lowest-peak side lobe”) has a direction corresponding to the central direction mentioned above. Accordingly, the first grating lobe T:GL1 of the transmission array antenna AT will be suppressed by the lowest-peak side lobe of the reception array antenna AR.

In this way, by setting the relationship “Dr=Dt×1.5” between the element interval Dt of the transmission antenna elements and the element interval Dr of the reception antenna elements, the amount of suppression of the first grating lobe of the transmission array antenna AT can be maximized.

Further, as indicated by the broken line in FIG. 4, the transmission array antenna AT has “three” side lobes and “four” null points between the directions of the main lobe T:ML and the first grating lobe T:GL1. Accordingly, the first grating lobe R:GL1 of the reception array antenna AR will be suppressed by the side lobes and the null points of the transmission array antenna AT.

Similarly, the transmission array antenna AT also has “three” side lobes and “three” null points distanced from the main lobe T:ML with reference to the direction of the first grating lobe T:GL1. Accordingly, the second grating lobe R:GL2 of the reception array antenna AR will be suppressed by the side lobes and the null points of the transmission array antenna AT.

Thus, by setting the relationship “Dr=Dt×1.5” between the element interval Dt of the transmission antenna elements and the element interval Dr of the reception antenna elements, the amount of suppression of the first grating lobe T:GL1 of the transmission array antenna AT can be maximized.

Further, the first grating lobe R:GL1 of the reception array antenna AR will be suppressed by the side lobes and the null points between the main lobe T:ML and the first grating lobe T:GL1 of the transmission array antenna AT. Furthermore, the second grating lobe R:GL2 of the reception array antenna AR will be suppressed by the side lobes and the null points distanced from the main lobe T:ML with reference to the first grating lobe T:GL1 of the transmission array antenna AT.

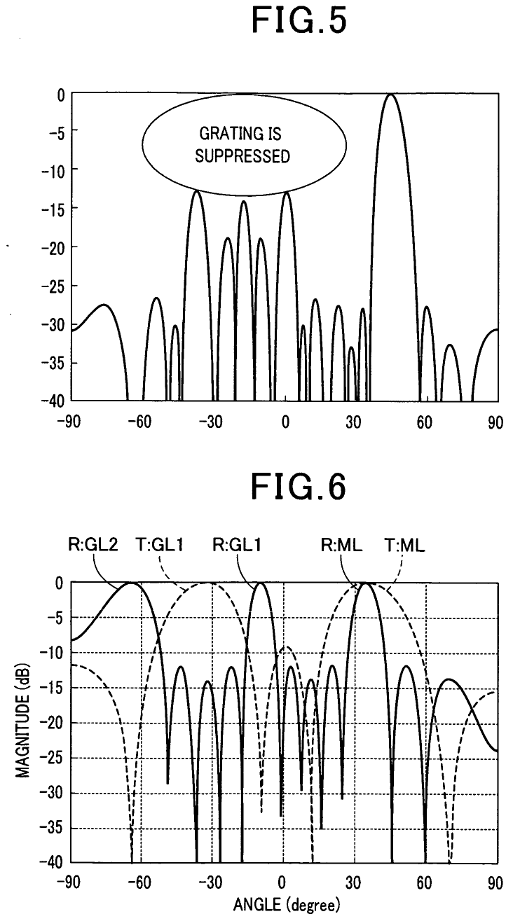

FIG. 5 is a diagram illustrating a composite transmission/reception directivity in which the directivity of the transmission array antenna AT and that of the reception array antenna AR are composed. As shown in FIG. 5, in the composite transmission/reception directivity, the direction θTGL1 of the first grating lobe T:GL1 of the transmission array antenna AT agrees with the direction of the null points or the direction of the side lobes of the reception array antenna AR. In addition, the directions θRGL1 and θRGL2 of the first and second grating lobes R:GL1 and R:GL2 of the reception array antenna AR agree with the direction of the null points or the direction of the side lobes of the transmission array antenna AT.

In other words, the first grating lobe T:GL1 of the transmission array antenna AT is suppressed, by about “10 dB”, by the null points or the side lobes of the reception array antenna AR. Similarly, the first and second grating lobes R:GL1 and R:GL2 of the reception array antenna AR are suppressed, by about “10 dB”, by the null points or the side lobes of the transmission array antenna AT.

However, when the element interval Dt of the transmission array antenna AT and the element interval Dr of the reception array antenna AR are set to have the relationship “Dr=Dt×1.5” as described above, the direction of a third grating lobe R:GL3, not shown, of the reception array antenna AR agrees with the direction of a second grating lobe T:GL2, not shown, of the transmission array antenna AT. Therefore, grating lobes occur in the composite transmission/reception directivlity.

When the direction in which the grating lobes have occurred enters the visible region, it is likely that a target may be erroneously detected. In order to avoid the occurrence of grating lobes in a visible region, the element interval Dt of the transmission array antenna AT is required to be an interval which will not permit the second grating lobe T:GL2 of the transmission array antenna AT to enter the visible region.

Specifically, the element interval Dt of the transmission array antenna AT is required to be set so that the following Expression (7) is satisfied. Expression (7) is obtained by allowing the direction “θ₀” of the main lobe to be “+90°” and by substituting “2” and “−90°” for the factor “m” and the direction “θ”, respectively, in Expressions (2) and (5) provided above. Here, the direction of the main lobe, i.e. “θ₀=+90°”, corresponds to the direction of one end of the visible region. Also, the conditions, i.e. “m=2” and “θ=−90°”, correspond to the conditions where the second grating lobe T:GL2 of the transmission array antenna AT occurs in the direction of the other end of the visible region.

$$0 < \frac{4 π}{λ} d < 4 π \qquad Expression ( 7 )$$

From the above Expression (7), it will be understood that, by setting the element interval Dt of the transmission array antenna AT to “Dt<λ”, the occurrence of grating lobes in the visible region can be avoided.

As mentioned above, there is the relationship “Dr=Dt×1.5” between the element interval Dt of the transmission antenna elements and the element interval Dr of the reception antenna elements. Therefore, the amount of suppression is maximized, which is caused by the side lobes of the reception array antenna AR to the first grating lobe T:GL1 of the transmission array antenna AT.

However, the relationship is not limited to “Dr=Dt×1.5”, but may be “Dt<Dr<Dt×2”. With this relationship as well, the first grating lobe T:GL1 of the transmission array antenna AT can be suppressed by the null points or the side lobes of the reception array antenna AR. This is because the direction of the first grating lobe T:GL1 of the transmission array antenna AT having the element interval Dt falls between the directions of the first and second grating lobes R:GL1 and R:GL2 of the reception array antenna AR having the element interval Dr.

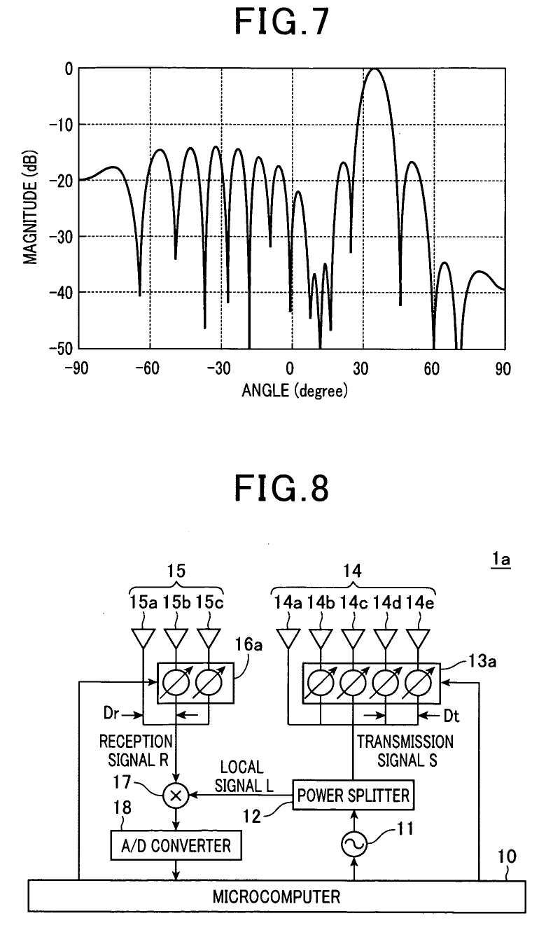

Referring now to FIGS. 6 and 7, the present embodiment will again be described further based on the method of suppressing grating lobes described above. FIG. 6 is a diagram illustrating the directivity of the transmission array antenna 14 and the directivity of the reception array antenna 15 with a solid line and a broken line, respectively. FIG. 7 is a diagram illustrating composite transmission/reception directivity in which the directivity of the transmission array antenna 14 and that of the reception array antenna 15 are composed.

In the present embodiment, the element interval Dt between the transmission antenna elements 14a to 14e and the element interval Dr of the reception antenna elements 15a to 15c have the relationship expressed by “Dr=Dt×1.5”.

Thus, as shown in FIG. 6, the direction θTGL1 of the first grating lobe T:GL1 of the transmission array antenna 14 falls between the directions θRGL1 and θRGL2 of the first and second grating lobes R:GL1 and R:GL2 of the reception array antenna 15.

Specifically, the direction θTGL1 of the first grating lobe T:GL1 of the transmission array antenna 14 agrees with the direction of the null points or the direction of the side lobes of the reception array antenna 15. In addition, the directions θRGL1 and θRGL2 of the first and second grating lobes R:GL1 and R:GL2 of the reception array antenna 15 agree with the direction of the null points or the direction of the side lobes of the transmission array antenna 14.

As shown in FIG. 7, in the composite transmission/reception directivity, the first grating lobe T:GL1 of the transmission array antenna 14 will be suppressed, by about “10 dB”, by the null points or the side lobes of the reception array antenna 15. Similarly, the first and second grating lobes R:GL1 and R:GL2 of the reception array antenna 15 will be suppressed, by about “10 dB”, by the null points or the side lobes of the transmission array antenna 14.

Also, in the present embodiment, with the wavelength λ being used for the radar apparatus 1, the element interval Dt of the transmission antenna elements 14a to 14e has been set to “0.9 times” of the wavelength λ, and the element interval Dr of the reception antenna elements 15a to 15c has been set to “1.35 times” of the wavelength λ. Thus, since the relationship “Dt<λ” mentioned above can be satisfied, grating can be prevented from occurring in the visible region (±90°).

According to the technique disclosed in the patent document JP-B-4147447 provided as conventional art, the element interval Dt had to be set to “one half” or less of the wavelength λ in order that no grating is caused in the visible region (±90°). In this regard, according to the present embodiment, the element interval Dt can be set to be larger than one half of the wavelength λ if the element interval Dt is smaller than the wavelength λ. Therefore, the transmission array antenna 15 can be more easily configured.

It should be noted that the transmission-side phase shifter 13 and the reception-side phase shifter 16 of the radar apparatus 1 correspond to a transmission-side directivity control unit and a reception-side directivity control unit, respectively.

The radar apparatus 1 related to the present invention is not limited to the configuration exemplified in the above embodiment, but may be variously modified within a scope not departing from the spirit of the invention. For example, the above embodiment may be appropriately modified and implemented as set forth below.

In the above embodiment, the transmission array antenna 14 has been configured to have “five” transmission antenna elements 14a to 14e. However, the number of the transmission antenna elements is not limited to this number. The number of the transmission antenna elements may be increased or decreased as required. Similarly, in the above embodiment, the reception array antenna 15 has been configured to have “three” reception antenna elements 15a to 15c. However, the number of the reception antenna elements is not limited to this number. The number of the reception antenna elements may be increased or decreased as required.

In the above embodiment, the transmission-side phase shifter 13 has been allowed to set the directivity of the transmission array antenna 14 by setting the amount of phase shift for each of the plurality of transmission signals S inputted to the transmission antenna elements 14a to 14e. However, the amount of phase shift may not necessarily be set for all of the plurality of transmission antenna elements 14a to 14e configuring the transmission array antenna 14.

For example, a radar apparatus 1a shown in FIG. 8, which corresponds to FIG. 1, may be configured. In this radar apparatus, the amount of phase shift of the transmission antenna element 14a among the transmission antenna elements 14a to 14e may be used as a reference to set the amounts of phase shift of the remaining transmission antenna elements 14b to 14e. In this case, since the phase of the transmission antenna element 14a is not required to be controlled, a transmission-side phase shifter 13a has no phase shifter for the transmission antenna element 14a. Thus, the directivity of the transmission array antenna 14 can also be controlled by controlling the phases of at least part of the plurality of transmission antenna elements 14a to 14e.

In the above embodiment, the reception-side phase shifter 16 has been allowed to set the directivity of the reception array antenna 15 by setting the amount of phase shift of each of the plurality of reception signals R inputted to the reception antenna elements 15a to 15c. However, the amount of phase shift may not necessarily be set for all of the plurality of reception antenna elements 15a to 15c configuring the reception array antenna 15.

For example, as in the radar apparatus 1a shown in FIG. 8, which corresponds to FIG. 1, the amount of phase shift of the reception antenna element 15a among the reception antenna elements 15a to 15c may be used as a reference to thereby set the amounts of phase shift of the remaining reception antenna elements 15b and 15c. In this case, since the phase of the reception antenna element 15a is not required to be controlled, a reception-side phase shifter 16a is not provided with a phase shifter for the reception antenna element 15a. Thus, the directivity of the reception array antenna 15 can also be controlled by controlling the phases of at least part of the plurality of reception antenna elements 15a to 15c.

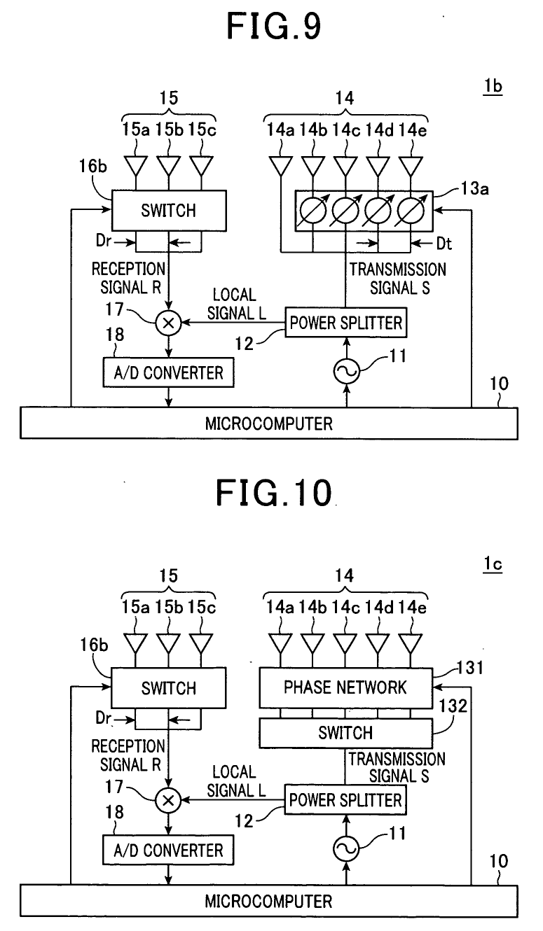

The reception-side phase shifter 16a may not necessarily be used in controlling the directivity of the reception array antenna 15. Alternative to the reception-side phase shifter 16a, a switch 16b may be used, for example, as shown in FIG. 9 that corresponds to FIG. 1 or 8, in controlling the directivity of the reception array antenna 15 to thereby perform digital processing, such as the well-known DBF (digital beam forming). With this configuration as well, the directivity of the reception array antenna 15 can be controlled.

Further, the transmission-side phase shifter 13a may not necessarily be used in controlling the directivity of the transmission array antenna 14. Alternative to the transmission-side phase shifter 13a, a phase network 131, such as the well-known Butler matrix, and a switch 132 may be used, as in the case of the radar apparatus 1c shown in FIG. 10 that corresponds to FIG. 1, 8 or 9, in controlling the directivity of the transmission array antenna 14. Specifically, the phase network 131 may be configured such that the transmission array antenna 14 would have five types of directivities, and the five types of directivities may be switched using the switch 132. Further, the switch 16b may be configured such that the reception array antenna 15 would have directivities corresponding to the respective five types of directivities of the transmission array antenna 14. With this configuration as well, the directivity of the transmission array antenna 14 can be controlled.

In the above embodiment, the transmission array antenna 14 has been configured as a planar antenna in which a plurality of transmission antenna elements are arrayed on a plane. However, the configuration is not limited to this. The transmission array antenna 14 may only have to be an array antenna, and thus a plurality of transmission antenna elements may not necessarily be arrayed on a plane.

Similarly, in the above embodiment, the reception array antenna 15 has been configured as a planar antenna in which a plurality of reception antenna elements are arrayed on a plane. However, the configuration is not limited to this. The reception array antenna 15 may only have to be an array antenna, and thus a plurality of reception antenna elements may not necessarily be arrayed on a plane.

In the above embodiment, the element interval Dt of the transmission antenna elements 14a to 14e and the element interval Dr of the reception antenna elements 15a to 15c have had the relationship “Dr=Dt×1.5”. Alternatively, a relationship “Dt<Dr<Dt×2” may be established.

In the above embodiment, when the wavelength of the radio waves used for the radar apparatus 1 is represented by λ, the element interval Dt of the transmission antenna elements 14a to 14e has been set to “0.9 times” of the wavelength λ. Alternative to this, the element interval Dt may be set to “0.99 times” or “0.5 times” of the wavelength λ. What matters is that the relationship “Dt<λ” may only have to be established.

In the above embodiment, since the scanning ranges of the transmission and reception array antennas 14 and 15 have each been set ranging “±90°”, the relationship “Dt<λ” has been set. However, the scanning ranges may not necessarily range “±90°”. When the scanning ranges of the transmission and reception array antennas 14 and 15 are set to range “±0”, a relationship “Dt<λ/sin θ” may only have to be established.

For convenience, the above embodiment has been described fixing the direction of the main lobe radiated from the transmission array antenna 14 to be “45°”. However, the main lobe of the transmission array antenna 14 can be scanned ranging from “−90°” to “+90°”. Thus, the directions of the null points and the side lobes of the reception array antenna 15 can be permitted to follow the direction of the main lobe of the transmission array antenna 14.

Hereinafter, aspects of the above-described embodiments will be summarized.

In order to achieve the above object, an array antenna apparatus of the embodiment has a composite transmission/reception directivity, in which the direction of a grating lobe of one of the transmission array antenna and the reception array antenna agrees with the direction of a null point or part of side lobes of the other of the transmission array antenna and the reception array antenna, and the direction of a grating lobe of the other of the transmission array antenna and the reception array antenna agrees with the direction of a null point or part of side lobes of the one of the transmission array antenna and the reception array antenna.

According to the configuration of the antenna apparatus, the grating lobe of the transmission array antenna is suppressed by the null points or the side lobes of the reception array antenna. Similarly, the grating lobe of the reception array antenna is suppressed by the null points or the side lobes of the transmission array antenna.

This means that, of the transmission array antenna and the reception array antenna, the direction of a second grating lobe of one array antenna (hereinafter referred to as “first array antenna”) does not agree with the direction of a first grating lobe of the other array antenna (hereinafter referred to as “second array antenna”). This is different from the above conventional art in which the direction of a second grating lobe on the grating suppressed side agrees with the direction of a first grating lobe on the grating suppressing side.

Compared to the above conventional art, the difference is that, in the composite transmission/reception directivity in the above configuration, the direction in which grating occurs will be more distanced from the direction of the main lobe, making it difficult for grating to occur in a visible region. Thus, with the above configuration, the visible region can be broadened without decreasing the element interval between the antenna elements.

In the array antenna apparatus, a relationship “Dt<Dr<Dt×2” is formed. This relationship allows the direction of a first grating lobe of the first array antenna to fall between the directions of a first grating lobe and a second grating lobe of the second array antenna. In this case, the second array antenna has a plurality of side lobes and a plurality of null points between the directions of the first and second grating lobes. Therefore, the first grating lobe of the first array antenna will be suppressed by the null points or the side lobes of the second array antenna.

Similarly, the first array antenna has a plurality of side lobes and a plurality of null points between the directions of the main lobe and the first grating lobe. Therefore, the first grating lobe of the second array antenna will be suppressed by the null points or the side lobes of the first array antenna.

Similarly, the first array antenna also has a plurality of side lobes and a plurality of null points distanced from the main lobe with reference to the first grating lobe. Therefore, the second grating lobe of the second array antenna will be suppressed by the null points or the side lobes of the first array antenna.

In the array antenna apparatus, a relationship “Dt<λ/sin θ” is formed. This relationship can prevent the occurrence of grating as well in the visible region when a scanning range is “±θ”.

In the array antenna apparatus, an element interval Dt and an element interval Dr are set to establish a relationship “Dr=Dt×1.5” and a relationship “Dt<λ” when the scanning range is “±90°”. This means that the direction of the first grating lobe of the first array antenna agrees with a central direction between the directions of the first and second grating lobes of the second array antenna. In this case, the second array antenna has a plurality of side lobes between the directions of the first and second grating lobes. Of the plurality of side lobes, the side lobe having the lowest peak is located at the central direction mentioned above. Accordingly, the first grating lobe of the first array antenna will be suppressed by the side lobe having the lowest peak of the second array antenna. Thus, according to the array antenna apparatus, the amount of suppression can be maximized.

Note that the array antenna apparatus may further include a phase shifter which controls phases of at least part of the reception antenna elements. The reception-side directivity control unit may control the directivity of the reception array antenna using the phase shifter.

Alternatively, the array antenna apparatus may further include a switch which controls phases of at least part of the reception antenna elements. The reception-side directivity control unit may control the directivity of the reception array antenna using the switch.

In order to achieve the above object, a radar apparatus includes the array antenna apparatus and an object detection unit which detects an object based on a reception signal, which is radio waves transmitted from the transmission array antenna and reflected by the object and is received by the reception array antenna. Thus, the radar apparatus can detect the object (target) using the array antenna apparatus.

It will be appreciated that the present invention is not limited to the configurations described above, but any and all modifications, variations or equivalents, which may occur to those who are skilled in the art, should be considered to fall within the scope of the present invention.

What is claimed is:

1. An array antenna apparatus, comprising:
a transmission array antenna which includes a plurality of transmission antenna elements;
a transmission-side directivity control unit which controls a directivity of the transmission array antenna by controlling phases of at least part of the plurality of transmission antenna elements;
a reception array antenna which includes a plurality of reception antenna elements; and
a reception-side directivity control unit which controls a directivity of the reception array antenna by controlling phases of at least part of the plurality of reception antenna elements, wherein
the array antenna apparatus has a composite transmission/reception directivity, in which the direction of a grating lobe of one of the transmission array antenna and the reception array antenna agrees with the direction of a null point or part of side lobes of the other of the transmission array antenna and the reception array antenna, and the direction of a grating lobe of the other of the transmission array antenna and the reception array antenna agrees with the direction of a null point or part of side lobes of the one of the transmission array antenna and the reception array antenna, and scans in a scanning range with the composite transmission/reception directivity.

2. The array antenna apparatus according to claim 1, wherein
an element interval Dt of one of the transmission antenna elements and the reception antenna elements and an element interval Dr of the other of the transmission antenna elements and the reception antenna elements have relationships of “Dt<Dr<Dt×2” and “Dt<λ/sin θ”, where λ is a wavelength of radio waves used for the array antenna apparatus, and “±θ” is the scanning range of the transmission array antenna and the reception array antenna.

3. The array antenna apparatus according to claim 2, wherein
the element interval Dt and the element interval Dr have relationships of “Dr=Dt×1.5” and “Dt<λ”, when the scanning range is “±90°”.

4. The array antenna apparatus according to claim 1, further comprising a phase shifter which controls phases of at least part of the reception antenna elements, wherein
the reception-side directivity control unit controls the directivity of the reception array antenna using the phase shifter.

5. The array antenna apparatus according to claim 1, further comprising a switch which controls phases of at least part of the reception antenna elements, wherein
the reception-side directivity control unit controls the directivity of the reception array antenna using the switch.

6. A radar apparatus, comprising:
the array antenna apparatus according to claim 1; and
an object detection unit which detects an object based on a reception signal, which is radio waves transmitted from the transmission array antenna and reflected by the object and is received by the reception array antenna.
